(19) United States
(12) Patent Application Publication
(10) Pub. No.: US 2017/0193439 A1
(43) Pub. Date: Jul. 6, 2017

(54) APPARATUS AND METHOD FOR MONITORING MERCHANDISE

(71) Applicant: Wal-Mart Stores, Inc., Bentonville, AR (US)

(72) Inventors: Nicholaus A. Jones, Fayetteville, AR (US); Robert J. Taylor, Rogers, AR (US); Matthew A. Jones, Bentonville, AR (US)

(21) Appl. No.: 15/398,508

(22) Filed: Jan. 4, 2017

Related U.S. Application Data
(60) Provisional application No. 62/275,172, filed on Jan. 5, 2016.

(51) Int. Cl. G06Q 10/08; G06K 7/14

(52) U.S. Cl. CPC G06Q 10/087; G06K 7/1413

(57) ABSTRACT

Systems, apparatuses, and methods are provided herein for monitoring merchandise. A system for monitoring merchandise comprises an item container configured to hold a plurality of items, an emitter matrix positioned to generate a plurality of emissions at an access plane of the item container, a sensor matrix positioned to detect the plurality of emissions at the access plane of the item container, and a control circuit configured to: measure a dimension of an item passing through the access plane of the item container based the plurality of emissions detected by the sensor matrix, identify an identity of the item based at least on the dimension of the item, and update inventory information associated with the item container stored in an inventory database based on the identity of the item.

### CROSS-REFERENCE TO RELATED APPLICATIONS

This application claims the benefit of U.S. Provisional Application No. 62/275,172, filed Jan. 5, 2016, which is incorporated herein by reference in its entirety.

### TECHNICAL FIELD

This invention relates generally to inventory tracking.

### BACKGROUND

Typically, in storage facilities and distribution centers, a variety of items are stored in a large number of storage spaces. To keep track of inventory levels and item locations, associates often have to manually record activities associated with inventory movement.

### BRIEF DESCRIPTION OF THE DRAWINGS

Disclosed herein are embodiments of apparatuses and methods for monitoring inventory. This description includes drawings, wherein:

FIG. 1 is a block diagram of a system in accordance with several embodiments.

FIG. 2 is a flow diagram of a method in accordance with several embodiments.

FIGS. 3A, 3B, 3C, and 3D are illustrations of emitter and sensor matrices in accordance with several embodiments.

FIGS. 4A and 4B are illustrations of sensor matrices in accordance with several embodiments.

FIG. 5 is a block diagram of a system in accordance with several embodiments.

FIG. 6 is a flow diagram of a process in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein for monitoring merchandise. A system for monitoring merchandise comprises an item container configured to hold a plurality of items, an emitter matrix positioned to generate a plurality of emissions at an access plane of the item container, a sensor matrix positioned to detect the plurality of emissions at the access plane of the item container, and a control circuit configured to: measure a dimension of an item passing through the access plane of the item container based the plurality of emissions detected by the sensor matrix, identify an identity of the item based at least on the dimension of the item, and update inventory information associated with the item container stored in an inventory database based on the identity of the item.

Conventionally, associates in a store may be required to make multiple barcode scans for various activities (e.g. picking, binning) for inventory tracking purposes. This process is often time-consuming and requires the use of one or both hands to scan the barcode on the item and/or enter the appropriate information.

In some embodiments, in the systems described herein, a “curtain” of lasers scans items entering and leaving a storage area and associates the scanned dimension data to the item/case. Once the item is systematically binned, the dimension information may be associated with the item. That item may be automatically un-binned when the light curtain detects an item with matching dimensions exiting the storage area. This process may reduce and/or eliminate the need to scan an item at the storage area when removing the item. In some embodiments, when the barcode of an item is scanned and the item is placed into the bin, a 2D profile of the item may be recorded and associated with that item barcode number. Subsequently, when that item is removed from a storage space, the 2D profile may be used to trigger an update to the inventory management system and automatically remove that item from the recorded content of that store area.

The system described herein may function to reduce the number of scans needed for inventory management and to reduce inventory errors. This system may also be used for error-checking or correction and to alert store associates and/or management of potential issues. For example, the system may detect that an item is scanned to be binned without actually being placed into the bin (without the curtain being broken). The system may also detect that an item is removed from a bin without being scanned to be un-binned and automatically remove that item from the recorded inventory associated with the bin.

The system generally incorporates sensor technology into individual storage locations to detect actions at that location and make systematic changes without requiring additional user action. The system may be configured to automatically react to human actions and take appropriate system action.

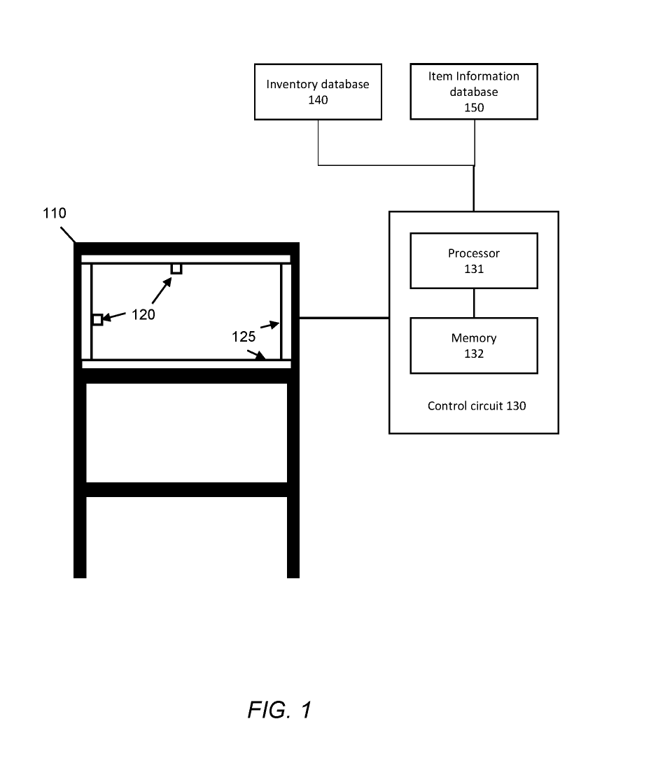

Referring now to FIG. 1, a system for monitoring merchandise is shown. An emitter matrix 120 and a sensor matrix 125 are positioned at or near an access plane of the item container 110. The sensor matrix 120 communicates with a control circuit 130 having a processor 131 and a memory 132. In some embodiments, the control circuit 130 further communicates with an inventory database 140 and an item information database 150.

The item container 110 comprises a storage space configured to hold a plurality of items. While the item container 110 is shown as a shelf in FIG. 1, in some embodiments, the item container 110 may comprise one or more of a shelf, a stand, a bin, a box, a chest, a case, and the like. Generally, an item container 110 may refer to any structure and/or a compartment of a structure configured to hold items for storage. The item container 110 includes an access plane through which items may be placed and/or removed from the storage space. In some embodiments, an access plane may comprise a plane covering an opening of the item container 110. For example, for a shelf, an access plane may cover the front-facing opening defined by the walls of the shelf.

The emitter matrix 120 comprises a plurality of emitters each directing an emission towards one or more sensors in the sensor matrix 125. Generally, the emissions of the emitter matrix 120 may be configured to substantially cover the access plane of the item container with emissions such that items passing through the access plane of the item container 110 would disrupt one or more emissions from the emitter matrix 120. In some embodiments, the emitter matrix 120 may comprise one or more of a laser emitter, a sonic emitter, a light emitter, and a radar emitter. In some embodiments, emissions may comprise one or more of: a laser beam, an ultrasound emission, a sonic emitter, a radar emission, a visible or invisible wavelength light beam, and the like. Generally, emissions may comprise any signal which may be detected by the sensor matrix 125 when a path of emission is clear and may be disrupted by the presence of a physical object in the path of emission.

In some embodiments, the emitter matrix 120 may comprise emitters that are configured to generate a narrow beam of emission such as a laser beam and/or a focused light beam. In some embodiments, the emitter matrix 120 may comprise emitters that are configured to generate a dispersed emission, such as ultrasound emission and radar emission. In some embodiments, the emitter matrix 120 may comprise one or more emitters that are configured to move when an item is placed or removed from the item container 110. In some embodiments, one or more emitters may be placed on a track at the access plane of the item container. In FIG. 1, for example, one emitter may be configured to move left and right on a horizontal track and a second emitter may be configured to move up and down on a vertical track. In some embodiments, the one or more emitters may be configured to pivot to direct a beam across the access plane.

In some embodiments, the sensor matrix 125 comprises one or more of a laser sensor, a sonic sensor, a light sensor, and a radar sensor. In some embodiments, each sensor in the sensor matrix 125 is paired with an emitter in the emitter matrix 120. In some embodiments, a sensor may be configured to detect emissions from a plurality of sensors and/or an emitter's emission may be detected by a plurality of sensors. In some embodiments, the sensor matrix 125 may comprise obstruction sensors that are configured to detect whether the emission from the emitter matrix 120 is obstructed or unobstructed by an object in the path of the emission. In some embodiments, the sensor matrix 125 may comprise one or more range and/or depth sensors configured to measure a distance between the sensor and an item.

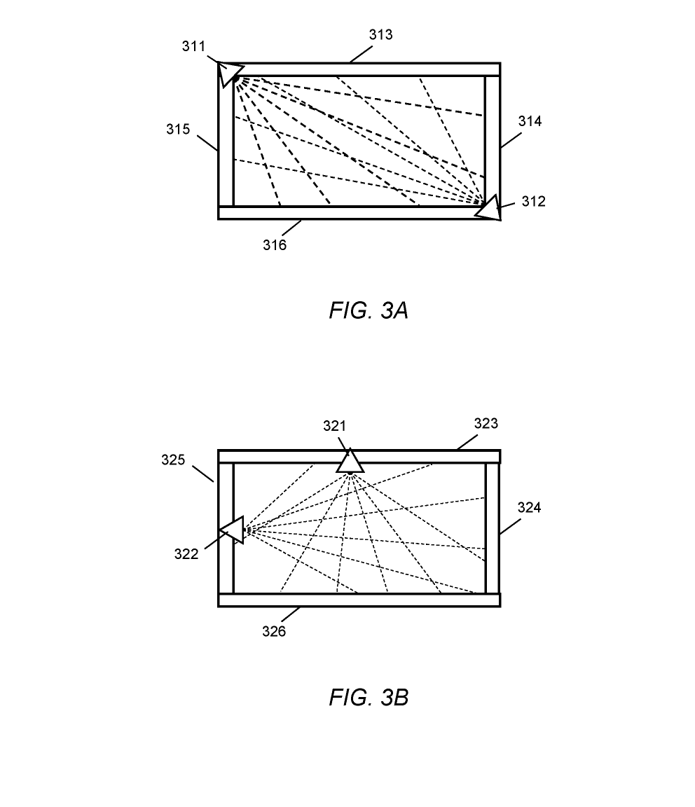

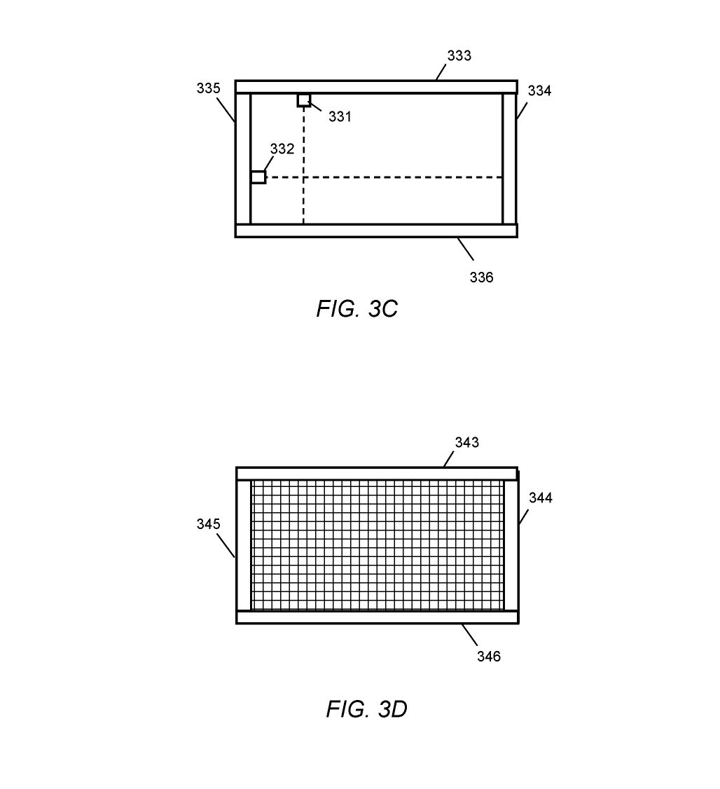

While FIG. 1 shows the emitter matrix 120 and the sensor matrix as separately positioned devices, in some embodiments, the emitter matrix 120 and the sensor matrix may comprise a co-located device. For example, the emitter and the sensor may be a reflection detector. In some embodiments, the emitter matrix 120 and the sensor matrix 125 may be positioned on only one side or two sides of the access plane of the item container 110. While the access plane is shown as a rectangle in FIG. 1 and the sensor matrix 125 and the emitter matrix 120 are each shown to be positioned on two sides of the rectangle, in some embodiments, the sensor matrix 125 and the emitter matrix 120 may be configured to cover access planes of other shapes. For example, the access plane may comprise a rectangular, circular, or irregularly shaped opening of the item container 110. In some embodiments, an emitter matrix 120 and/or a sensor matrix 125 may be configured to cover two or more opening of an item container. Examples of embodiments of emitter and sensor matrices are described with reference to FIGS. 3A-B and 4A-B herein.

In some embodiments, the emitter matrix 120 and the sensor matrix 125 may further comprise an optical code scanner. For example, the emitter matrix 120 may comprise laser diodes and the sensor matrix 125 may use the reflect laser beams to read a barcode, a QR code, a UPC, etc. In some embodiments, the item container 110 may further include a separate item identifier scanner such as a barcode scanner, a radio field identification (RFID) tag scanner, and the like. In some embodiments, the system may comprise a separate handheld scanner operated by an associate that communicates with the control circuit 130.

In some embodiments, the sensor matrix 125 may include a wired or wireless communication device (not shown) for communicating with the control circuit 130. In some embodiments, the sensor matrix 125 may communicate with the control circuit via one or more of a short-range wireless communication channel, a Wi-Fi connection, a wired connection, a local area network connection, a Bluetooth connection, etc.

The control circuit 130 includes a processor 131 and a memory 132 and may generally be any processor-based device. The processor 131 may comprise a central processing unit, a processor, a microprocessor, and the like. The control circuit 130 may be configured to execute computer readable instructions stored on the memory 132. The memory 132 may comprise volatile and/or non-volatile computer readable storage memory and have stored upon it a set of computer readable instructions which, when executed by the control circuit 130, cause the system to update inventory information based on the dimension of an item that passes through the access plane of the item container 110 covered by the emissions of the emitter matrix 120. The control circuit 130 may further comprise a communication device for communicating with the sensor matrix 125.

In some embodiments, the control circuit 130 may further communicate with an item information database 150 and an inventory database 140. The item information database 150 and the inventory database 140 may each comprise volatile and/or non-volatile computer readable storage memory. The item information database 150 may store a number of unique item identifiers (e.g. Universal Product Code (UPC). barcode, RFID code, QR code, etc.) with dimension information for at least some of the items. For example, the item information database may include item height, width, and/or length information. In some embodiments, the item information database may store a plurality of dimension information for each unique item identifier associated with different packaging types. For example, for one unique item identifier, the item information database 150 may store dimension information for a case of items, a box of items, a display pack of items, a vendor pack of items, a multipack of items, an individual item, etc. In some embodiments, the item information database 150 may further include other item information such as item name, item expiration date, item category, item visual characteristic, etc. Generally, the control circuit 130 may be configured to use the item information database 150 to identify an item passing through the access plane of the item container 110 based on the readings of the sensor matrix 125. In some embodiments, the control circuit 130 may further obtain a unique item identifier when an item passes through the access plane of the item container 110 and store the unique item identifier and the measured dimension of the item in the item information database 150. In some embodiments, the item information database 150 may also store one or more storage locations for each item. For example, each item container may have an associated item container identifier, and item information database 150 may associate one or more items with item container identifier to indicate which container(s) the items are supposed to be stored.

The inventory database 140 may store item location and quantity information for one or more storage facilities. For example, the inventory database 140 may associate a unique storage area identifier with one or more items stored in the storage area. Each unique storage area identifier may correspond to a defined storage area such as an item container structure and/or a compartment of the structure. In some embodiments, the inventory database 140 may further include information on items expected to be stored in each storage area. When the control circuit 130 detects that an item is added and/or removed from an item container, the inventory database 140 may be updated to reflect the change in inventory in that item container.

While the memory 132 of the control circuit 130, the inventory database 140, and the item information database 150 are shown as three elements in FIG. 1, in some embodiments, one or more of the memory 132 of the control circuit 130, the inventory database 140, and the item information database 150 may be implemented with one or more shared physical memory devices and/or may be implemented in one or more shared database structures. For example, in some embodiments, the item information database 150 may be implemented as part of the inventory database 140.

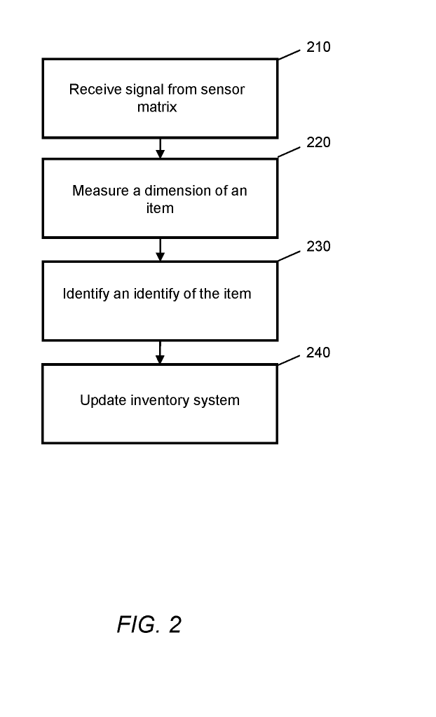

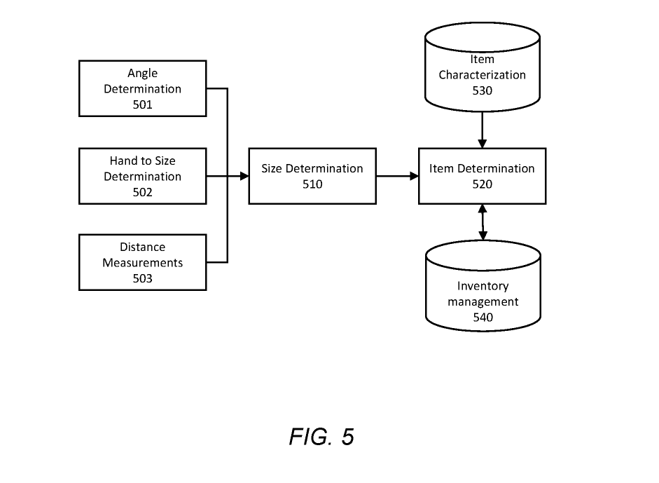

Referring now to FIG. 2, a method for monitoring merchandise is shown. Generally, the method shown in FIG. 2 may be implemented with a processor based device such as a control circuit, a central processor, and the like. In some embodiments, the method shown in FIG. 2 may be implemented with the control circuit 130 shown in FIG. 1 and/or one or more modules described with reference to FIG. 5 herein.

In step 210, the system receives signals from a sensor matrix. The sensor matrix may be configured to detect emission(s) from an emitter matrix at an access plane of an item container configured to hold a plurality of items. In some embodiments, the signals may be received from the sensor matrix 125 shown in FIG. 1. The signal may include detections of emissions from a plurality of sensors in the sensor matrix. In some embodiments, the signal may be a I/O signal from each sensor in the sensor matrix representing whether an emission is detected or obstructed at the sensor location. In some embodiments, the signal may comprise a range/depth measurement providing distances from each sensor to an object in the path of the emission. In some embodiments, the signal received in step 210 may be associated with an item being placed into or removed from the item container.

In step 220, the system measures a dimension of an item passing through the access plane of the item container based on the plurality of emissions detected by the sensor matrix. Generally, the dimension of the item may comprise one or more of the width, height, length, volume, 2D profile, and/or 3D model of the item. In some embodiments, the system determines a two dimensional (2D) profile of the item. In some embodiments, the system counts how many sensors in the sensor matrix does not detect an emission from an emitter to determine the width and height of the item. For example, if ten consecutive sensors on the horizontal portions of the sensor matrix and twenty consecutive sensors on the vertical portion of the sensor matrix detect disruption in the emission, and each sensor in the sensor matrix are spaced apart by 1 cm, the system may determine that the item has a 10 cm by 20 cm 2D profile. In some embodiments, the emitter matrix and the sensor matrix may be configured to determine distances between the item and each sensor in the sensor matrix. The system may then use the measured distances to build a 2D profile of the item. In some embodiments, the system may capture a plurality of 2D profiles of an item at time intervals to determine an orientation of the item. For example, if the item is rotated with respect to the access plane, the width of the 2D profile at a given time may be smaller or larger than the actual width of the item. The system may adjust the 2D profile of the item based on the determined orientation of the item.

In some embodiments, in step 220, the system may further determine a length of the item. In some embodiments, one or more sensors in the sensor matrix may comprise a motion sensor that is configured to measure the distance that the item has moved to determine the length of the item. For example, the motion sensor may comprise an optical motion tracker similar to the sensor in an optical computer mouse. In some embodiments, the motion sensor may further be used to determine whether the item is being placed into or removed from the item container. In some embodiments, the system may assume a typical movement speed for an item and measure the duration of time that the item disrupts to light curtain generated by the emitter matrix to estimate a length of the item.

In some embodiments, in step 220, the system may further determine an estimated volume of the item. In some embodiments, for generally box-shaped items, the volume of the item may be derived by multiplying the 2D profile of the item with the measured or estimated length of the item. In some embodiments, for irregularly shaped items, the system may capture multiple 2D profiles the item at intervals to construct a 3D model of the item to estimate the item's volume. In some embodiments, the system may construct a 3D model using the sensor matrix and use the 3D model for identifying an item in step 230. In some embodiments, the dimension of the item may be obtained through known 2D and/or 3D scanning methods.

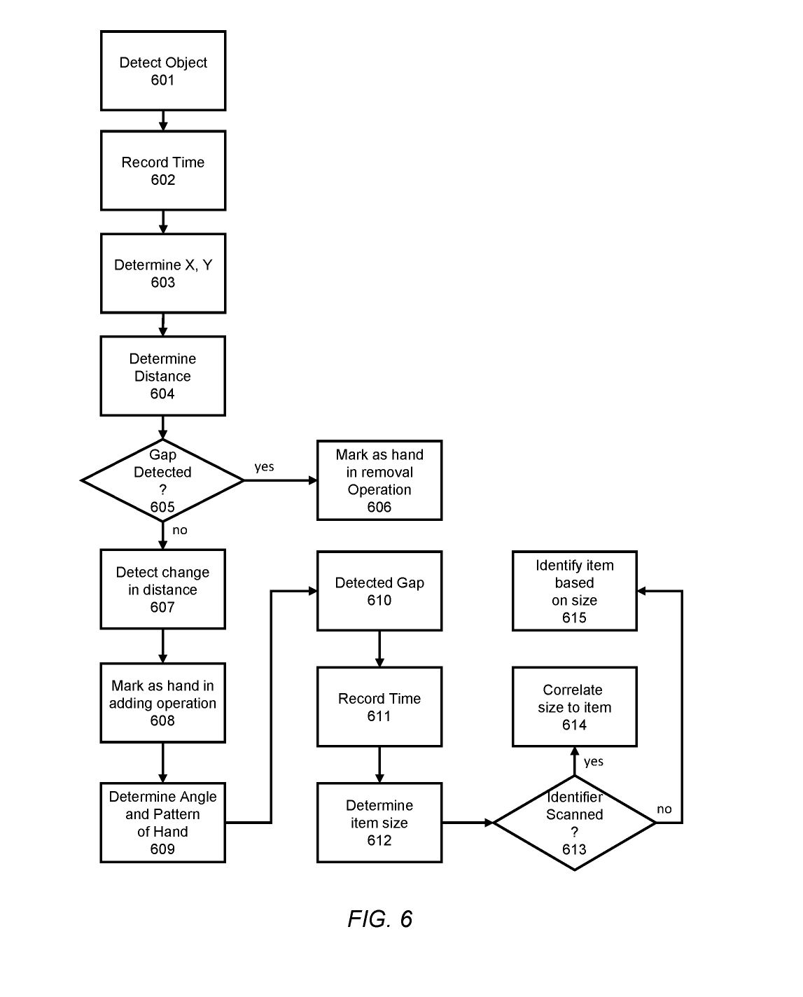

In some embodiments, in step 220, the system may further detect the presence of a human body portion such as arms and/or hands of a person placing and/or removing the item, and subtract the dimensions associated with the body portion from the scanned dimension to determine the item's dimension. In some embodiments, a body portion may be detected by comparing portions of the detected shape with a typical body portion profile. For example, the system may be configured to detect a hand based on the distinct shape of fingers and palm. In another example, the system may be configured to determine that a pair of spaced apart objects passing through the access plane of the item container corresponds to a pair of hands reaching into the item container. In some embodiments, when an item is placed into the item container, the system may measure the dimension of the hand(s) and/or arm(s) when they exit the item container after placing the item, and subtract the dimension of the hand(s) and/or arm(s) from the earlier measurements taken when the item entered the item container with the hand(s) and/or arm(s). In some embodiments, when an item is removed from the item container, the system may measure the dimension of the hand(s) and/or arm(s) when they reach into the item container to retrieve an item, and subtract the dimension of the hand(s) and/or arm(s) from the measurements taken when the item later exits the item container with the hand(s) and/or arm(s) holding the item. In some embodiments, for generally box-shaped items, the system may capture a plurality of 2D profiles of the item and select the profile most resembling a square or a rectangle as the 2D profile to remove any dimensions associated with human body portions. In some embodiments, the system may be configured to base the dimension measurement only on substantially straight and/or smooth lines in the 2D profile and/or the 3D model. An example process for determining the dimension of an item in accordance with some embodiments is provided with reference to FIG. 6 herein.

In some embodiments, the system may detect for the distance between two joints and/or knuckles on a human hand in the 2D profile and/or the 3D model obtained from the sensor matrix. The distance between two joints and/or knuckles may be assumed to correspond to a typical distance between joints of a human hand (e.g. 1 inch). In some embodiments, the system may further estimate a height of the person placing or removing an item based on the angle of the hand and/or the arm in the 2D profile and/or the 3D model. For example, a taller person's hands would be angled more when placing or retrieving items from a lower storage area. The estimated height of the person may then be used to estimate the distance between joints and/or knuckles on his/her hand. For example, a 5-foot tall person may, on average, have joints that are 0.8 inches from each other and 6 foot 4 inches tall person may, on average, have joints that are 1.2 inches from each other. These numbers are provided for illustration only and may not correspond to actual data. The estimated distance between joints and/or knuckles of a hand in a 2D or 3D profile may be used as a reference distance in determining an item's dimensions. For example, if the item's height is five times greater than the distance between two joints/knuckles on a hand holding it, which is assumed to be one inch, the height of the item may be estimated to be five inches.

In step 230, the system determines an identity of the item based on the dimension of the item measured in step 220. The identity of the item may be determined based on one or more of the width, height, length, volume, 2D profile, and/or 3D model of the item. In some embodiments, the system may compare the measured dimension of the item with the dimension of one or more items in an item information database. In some embodiments, the dimension information in the item information database may be originally captured by a sensor matrix coupled to an item container. For example, when an item is placed into an item container, an identifier on the item may be scanned with a handheld and/or on-shelf scanner. The system may then store the dimension information measured using a sensor matrix in the item information database with the item identifier. This information stored in the item information database may then be used by the system to determine the identity of other items placed into and/or removed from item containers. In some embodiments, the dimension information in the item information database may include dimension information provided by other sources such as manufacturer specification and manual measurement.

In some embodiments, the item may be identified based on expected inventory information for the associated item container. For example, based on inventory management information, three types of items are expected to be stored in an item container. The measured dimension may then only be compared to the three types of items to determine the identity of the item. In some embodiments, if the dimension measured in step 220 does not match any items expected to be in the item container according to the inventory management system, the system may generate a misplaced item alert. In some embodiments, when an item is being removed, the measured dimension may only be compared with items known to have been previously placed into the item container to determine the identity of the item.

In some embodiments, in step 230, the system may further determine a packaging type of the item. In some embodiments, an item identifier may be associated with a plurality of packaging types such as a case of items, a box of items, a display pack of items, a vendor pack of items, a multipack of items, an individual item, etc. Based on the dimension measurement, the system may determine an identity of the item and/or the packaging type of the item.

In step 240, the system updates the inventory information associated with the item container. The inventory information may be stored in an inventory database accessible by one or more systems. The updated inventory information may be based on the identity of the item determined in step 230. For example, if the item identified in step 240 is removed from the item container, the inventory record of items stored in the item container may be reduced by one count in the inventory information database. If the item identified in step 240 is added to the item container, the inventory record of items stored in the item container may be increased by one count in the inventory information database. In some embodiments, the inventory information may differentiate between different packaging types for an item and the inventory information for each packing type may be updated separately. With the process described with reference to FIG. 2, inventory of items in a plurality of item containers in a storage facility may be tracked by measuring dimensions of items placed and removed from each the item container without having to scan the item identifiers on the items with each action.

Next referring to FIGS. 3A-D, illustrations of several embodiments of emitter matrices are shown. In FIG. 3A, an emitter matrix comprises a first emitter 311 and a second emitter 312 and a sensor matrix comprises four sensor bars 313, 314, 315, and 316. The dashed lines generally represent emissions generated by the emitters 311 and 312. In FIG. 3A, emitters 311 and 312 are placed at opposite corners of the access plane of an item container. In some embodiments, emitters 311 and 312 and/or emission reflectors may be configured to pivot across the access plane to cover the access plane with emission. In some embodiments, the emitters 311 and 312 may be generally stationary and configured to generate a dispersed emission that covers a substantial portion of the access plane. In some embodiments, the emitters 311 and 312 may comprise a plurality of emitter devices pointed in different directions to cover the access plane. Each sensor bar 313-316 may comprise a plurality of sensors each configured to detect whether an emission from the emitter 311 and 312 is obstructed by an object. In some embodiments, the sensors may instead be co-located with the emitters. For example, the emitters 311 and 312 may comprise co-located sensors configured to detect emissions reflected from the surface of an object. In some embodiments, the co-located sensors may further be configured to determine distances from each sensor to the item based on the time of travel of the reflected emission. In some embodiments, a third emitter and a fourth emitter may be added to the other corners of the access plane to provide additional data for determining the dimension of the item passing through the access plane.

In FIG. 3B, an emitter matrix comprises a first emitter 321 and a second emitter 322 and a sensor matrix comprises four sensor bars 323, 324, 325, and 326. In some embodiments, FIG. 3B may correspond to an alternate placement of emitters described with reference to FIG. 3A. In FIG. 3B, emitters 321 and 322 are placed along a horizontal side and a vertical side of the access plane respectively. In some embodiments, emitters 321 and 322 and/or reflector may be configured to pivot left and right and up and down respectively to cover the access plane with emission. In some embodiments, the emitters 321 and 322 may be stationary and configured to generate a dispersed emission that covers a substantial portion of the access plane. In some embodiments, the emitters 321 and 322 may comprise a plurality of emitter devices pointed in different directions. Each sensor bar 323-326 may comprise a plurality of sensors each configured to detect whether the path of emission from the emitter 321 and 322 is obstructed by an object at each sensor location. In some embodiments, the sensors may instead be co-located with the emitters. For example, the emitters 321 and 322 may comprise co-located sensors configured to detect emissions reflected from the surface of an item. In some embodiments, the co-located sensors may further be configured to determine distances from the sensors to the item based the time of travel of the reflected emission.

In FIG. 3C, an emitter matrix comprises a first emitter 331 and a second emitter 332. The first emitter 331 may be mounted on a horizontal track 333 and may be configured to travel left and right on the horizontal track 333. The second emitter 332 may be mounted on a vertical track 335 and may be configured to travel up and down on the vertical track 335. In some embodiments, the horizontal track 333 and the vertical track 335 may extend through a plurality of item container spaces. For example, the first emitter 331 and the second emitter 332 may be moved to the item container having an item added or removed and moved across the access plane of the item container to generate a curtain of light covering the access plane of that item container. In some embodiments, the emitters 331 and 332 may comprise co-located sensors configured to detect emissions reflected from the surface of an item. In some embodiments, the co-located sensors may further be configured to determine distances from the sensors to the item based on the time of travel of the reflected emission. In some embodiments, a sensor matrix may be implemented within the horizontal track 333 and the vertical track 335. In some embodiments, a sensor matrix may further include bars 434 and 436 each having a plurality of sensors. In some embodiments, sensors may be mounted on a track opposite a corresponding emitter and move in parallel with the emitter to scan an item.

In FIG. 3D, an emitter matrix comprises a horizontal bar of emitters 343 and a vertical bar of emitters 345 and a sensor matrix comprises a horizontal bar of sensors 346 and a vertical bar of sensors 344. In some embodiments, the emitters and the sensors in FIG. 3D may generally be stationary. In some embodiments, emissions from the horizontal bar of emitters 343 may be generally perpendicular to the emissions from the vertical bar of emitters 345. In some embodiments, each sensor in the sensor matrix may be configured to detect emissions from one or more corresponding emitters in the emitter matrix. In some embodiments, the horizontal bar of sensors 346 may be co-located with the horizontal bar of emitters 343 to detect the reflected emissions. In some embodiments, the vertical bar of sensors 345 may be co-located with the vertical bar of emitters 345 to detect the reflected emissions.

FIGS. 3A-D are provided as examples of emitter and sensor matrices only. Generally, the emitter and sensor matrices may be placed in any position such that the emissions from the emitters substantially cover the access plane of one or more item containers and the sensors are positions to detect obstructions in the path of the emission. Generally, emitters and sensors may be positioned on one, two, three, or four sides of an access plane of an item container.

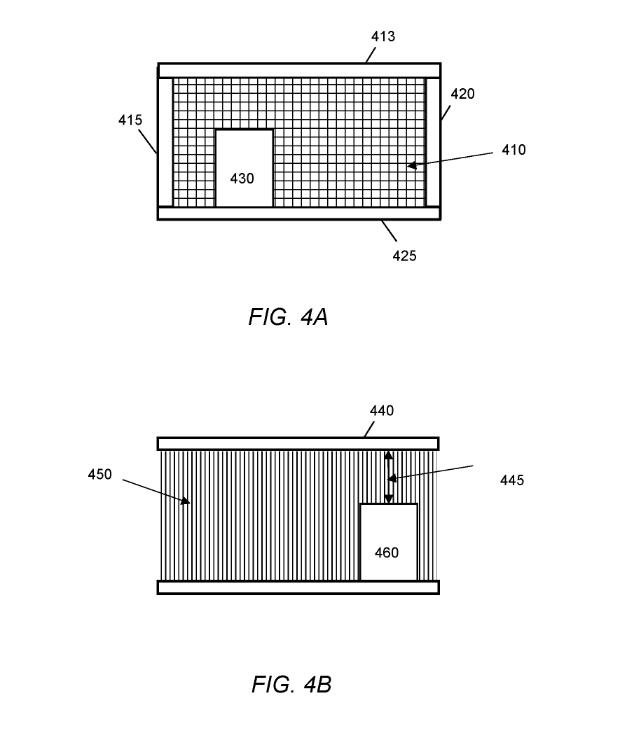

Next referring to FIGS. 4A-B, illustrations of sensor matrices measuring a dimension of an item are shown. In FIG. 4A, an item 430 passes through a light curtain 410 covering an access plane of an item container. In some embodiments, the light curtain 410 may comprise emissions generated by one or more emitter matrices described with reference to FIGS. 1 and 3A-D herein. In some embodiments, the sensor matrix may comprise a vertical sensor bar 420 and a horizontal sensor bar 425. Each sensor bar may comprise a plurality of sensor devices positioned in a row. The sensors may be configured to measure a dimension of the item by measuring the height and/or width of the detected disruption of emission. For example, the number of sensors on the vertical sensor bar 420 that detects a disrupted emission may correspond to the height of the item 430 and the number of sensors on the horizontal sensor bar 425 that detects a disrupted emission may correspond to the width of the item 430. In some embodiments, the sensor matrix may further include one or more of a second horizontal bar 413 and a second vertical bar 415 for detecting emissions from other angles. For example, for non-rectangular items, the additional sensor bar may provide more measurements on different sides of the item. In some embodiments, the emissions detected by the sensor matrix may comprise direct and/or reflect emission. In some embodiments, the sensors may determine whether an emission is obstructed based on the strength of the detected emission.

In FIG. 4B, an item 460 passes through a light curtain 450 covering an access plane of an item container. In some embodiments, the light curtain 410 may comprise emissions generated by one or more emitter matrices described with reference to FIGS. 1 and 3A-D herein. In some embodiments, the dimension of the item 460 is measured by co-located emitter and sensor matrices 440. The co-located emitter and sensor matrices 440 may be configured to measure distances 445 between each sensor of the sensor matrix and the item 460 and/or the opposite wall of the item container. The co-located emitter and sensor matrices 440 may determine a 2D profile of the item 460 based on the distance measurements. In some embodiments, a second set of co-located emitters and sensors may be positioned parallel or perpendicular to the co-located emitter and sensor matrices 440 to provide additional distance measurements for non-rectangular items. While FIG. 4B shows the co-located emitter and sensor matrices 440 on a horizontal edge of the access plane, in some embodiments, the co-located emitter and sensor matrices 440 may be positioned on a vertical edge of the access plane.

Next referring to FIG. 5, a block diagram of a system for monitoring inventory is shown. In FIG. 5, data collected by a sensor matrix described herein is processed with one or more of an angle determination module 501, a hand to size determination module 502, and a distance measurement module 503. The angle determination module 501 may be configured to determine an orientation of an item entering or exiting an item container. For example, the system may capture a plurality of 2D profiles of an item to determine the orientation of the item. In another example, the system may measure a change in the distance between a sensor matrix and the item to determine the orientation angle of the item passing through the access plane.

The hand to size determination module 502 may be configured to determine dimension measurements associated with a human body portion such as a hand and/or an arm of a person placing and/or removing an item. The hand to size determination module 502 may then subtract the dimensions of the body portion from the scanned dimension to determine the item's dimension. In some embodiments, a body portion may be detected by comparing the detected shape with a typical a body portion profile. For example, the system may be configured to detect a hand based on the distinct shape of fingers and palm. In another example, the system may be configured to determine that a pair of spaced apart objects at the access plane corresponds to a pair of hands. In some embodiments, when an item is placed into the item container, the system may measure the dimension of the hand(s) and/or arm(s) as they exit the item container and subtract the dimension of the human body portion(s) from the measurements taken when the item enters the item container at an earlier time. In some embodiments, when an item is removed from the item container, the system may measure the dimension of the hand(s) and/or arm(s) as they reach in to retrieve an item and subtract the dimension of the human body portion(s) from the measurements taken when the item exits the item container at a later time. In some embodiments, for generally box-shaped items, the system may capture a plurality of 2D profiles of the item and select the profile most resembling a square or a rectangle as the 2D profile to remove any dimensions associated with body portions. In some embodiments, the system may be configured to base the dimension measurement only on substantially straight and/or smooth lines in the measured 2D profile and/or 3D model.

In some embodiments, the system may detect for the distance between two joints and/or knuckles on a human hand in the 2D profile and/or the 3D model measured by the sensor matrix. The distance between two joints and/or knuckles may be assumed to correspond to a typical distance between joints of a human hand (e.g. 1 inch). In some embodiments, the system may further estimate a height of the person placing or removing an item based on the angle of the hand and/or the arm in the 2D profile and/or the 3D model. For example, a taller person's hands would be angled more when placing or retrieving items from a lower storage area. The estimated height of the person may be used to estimate the distance between joints and/or knuckles on his/her hand. For example, a 5-foot tall person may, on average, have joints that are 0.8 inches from each other and 6 foot 4 inches tall person may, on average, have joints that are 1.2 inches from each other. These numbers are provided for illustration only and may not correspond to actual data. The estimated distance between joints and/or knuckles of a hand in a 2D or 3D profile may be used as a reference distance in determining an item's dimensions. For example, if the item's height is five times greater than the distance between two joints/knuckles on a hand holding it, which is assumed to be one inch, the height of the item may be estimated to be five inches.

The distance measurement module 503 may be configured to determine a length of the object. In some embodiments, one or more sensors in the sensor matrix may comprise a motion sensor that is configured to measure the amount that the item has moved at set intervals to determine the length of the item. For example, the motion sensors may comprise motion sensors similar to an optical computer mouse. In some embodiments, the motion sensor may further be used to determine a direction of movement to determine whether the item is being placed into or removed from the item container. In some embodiments, the system may assume a typical movement speed for an item and measure the duration of time that the item disrupts to signal curtain generated by the emitter matrix to estimate a length of the item.

In some embodiments, the angle determination module 501, the hand to size determination module 502, and the distance measurement module 503 may exchange information to determine the object orientation, the body portion dimension, and the object length. The information from the angle determination module 501, the hand to size determination module 502, and the distance measurement module 503 may be used by the size determination module 510 to determine a dimension of the item. The dimension of the item may comprise one or more of the width, height, length, volume, 2D profile, and/or 3D model of the item.

The item dimension determined by the size determination module 510 may be used by the item determination module 520 to determine an identity of an item. The item determination module 520 may compare the dimension of the item with item information in the item characterization database 530. In some embodiments, the identity of the item may further be identified based on the expected inventory associated with the item container stored in the inventory management database 540. After the item determination module 520 identifies the item, the inventory information associated with the item and the item container may be updated in the inventory management database 540.

Next referring to FIG. 6, a process for identifying an item is shown. Generally, the process shown in FIG. 6 may be implemented with a processor based device such as a control circuit, a central processor, and the like. In some embodiments, the method shown in FIG. 6 may be implemented with the control circuit 130 shown in FIG. 1 and/or one or more modules described with reference to FIG. 6 herein.

In step 601, the system detects an object. In some embodiments, the object may be detected by one or more of the sensors in a sensor matrix. In step 602, the system records the time that the item first breaks a light curtain at the access plane of the item container. In step 603, the system determines the width (x) and the height (y) of the objects(s) passing through the access plane. In step 605, the system determines a distance between portions of the object detected in step 601.

In step 605, the system determines whether the 2D profile of the object contains a gap. The gap may correspond to a gap between two hands/arms of a person reaching in to retrieve an item. If a gap is detected, in step 606, the dimension of the object is marked as a body portion in an item removal operation. The dimension of the hands entering the item container may be stored and used to determine the dimension of the item when the item exits the item container being held by the hands.

If no gap is detected in step 605, in step 607, the system detects a change in the distance of between portions of the object. In step 608, the system marks the detected change in distance as being associated with hands/arms in an add item operation. In step 608, using the measurements, the system determines an angle and pattern of the hand(s) holding the item. In some embodiments, the dimension of the hands/arms may be determined based on package size by comparing the measurements of the hand/arms with the known size of the package. In some embodiments, the system may assume that the distance between two joints corresponds to one inch and determine the dimension of the hand based on detecting the distance between joints of the hand. In step 610, a gap is detected, indicating that the hands/arms the item has completely passed through the access plane. In step 611, the end time of the adding operation is recorded. In step 612, the start time recorded in step 602 and the end time recorded in step 611 are used to estimate a length of the item. The width and height of the item measured in step 603 may be combined with the length of the item to estimate a volume of the item.

In step 613, if an item identifier is scanned when an item is placed, the measured size of the item is correlated in an item information database in step 614. If an item identifier is not scanned in step 613, the item may be identified based on the measured size information in step 615 by looking up the item's identity in the items information database.

In one embodiment, a system for monitoring merchandise comprises an item container configured to hold a plurality of items, an emitter matrix positioned to generate a plurality of emissions at an access plane of the item container, a sensor matrix positioned to detect the plurality of emissions at the access plane of the item container, and a control circuit configured to: measure a dimension of an item passing through the access plane of the item container based the plurality of emissions detected by the sensor matrix, identify an identity of the item based at least on the dimension of the item, and update inventory information associated with the item container stored in an inventory database based on the identity of the item.

In some embodiments, the system and the sensor matrix described herein may be used to monitor merchandise on the sales floor and/or in a storage area. In some embodiments, the system may function to secure regulated and/or high value items. For example, a sensor matrix may be positioned at the opening of a display case for one or more of guns, ammunition, razors, jewelry, electronics, etc. to detect for and prevent unauthorized access to the products. In some embodiments, when a person reaches into the display case, the system may determine the person's identity via an RFID tag on a user device, facial recognition, voice recognition, passcode keypad, etc. The system may then identify the item being removed as described herein and determine whether the person is authorized to remove the identified item from the storage area. In some embodiments, the system may cause an alarm to be triggered if unauthorized access is detected by the sensor matrix.

In one embodiment, a method for monitoring merchandise comprises receiving signals from a sensor matrix configured to detect a plurality of emissions at an access plane of an item container configured to hold a plurality of items, the plurality of emissions being emitted by an emitter matrix, measuring a dimension of an item passing through the access plane of the item container based the plurality of emissions detected by the sensor matrix, identifying an identity of the item based at least on the dimension of the item, and updating inventory information associated with the item container stored in an inventory database based on the identity of the item.

In one embodiment, an apparatus for monitoring merchandise comprises an emitter matrix configured to emit a plurality of emissions at an access plane of an item container configured to hold a plurality of items, and a sensor matrix configured to detect the plurality of emissions to determine a dimension of an item passing through the access plane of the item container. Wherein the dimension of the item is used to identify an identity of the item and update inventory information associated with the item container stored in an inventory database.

In one embodiment, a system for monitoring merchandise comprises an item container configured to hold a plurality of items, an emitter matrix positioned to generate a plurality of emissions at an access plane of the item container, a sensor matrix positioned to detect the plurality of emissions at the access plane of the item container, a control circuit configured to: measure a dimension of an item passing through the access plane of the item container based the plurality of emissions detected by the sensor matrix, receive an item identifier from scanning a machine optically readable code on the item with an optical reader, and associate the dimension of the item with the item identifier in an inventory database.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for monitoring merchandise, comprising:
an item container configured to hold a plurality of items;
an emitter matrix positioned to generate a plurality of emissions at an access plane of the item container;
a sensor matrix positioned to detect the plurality of emissions at the access plane of the item container; and
a control circuit configured to:
measure a dimension of an item passing through the access plane of the item container based the plurality of emissions detected by the sensor matrix;
identify an identity of the item based at least on the dimension of the item; and
update inventory information associated with the item container stored in an inventory database based on the identity of the item.

2. The system of claim 1, wherein the emitter matrix comprises one or more of a laser emitter, a sonic emitter, a light emitter, and a radar emitter.

3. The system of claim 1, wherein the emitter matrix and the sensor matrix comprise at least an optical reader configured to read an optically readable identifier on the item, and the control circuit is configured to identify the identity of the item further based on the optically readable identifier.

4. The system of claim 1, wherein the emitter matrix and the sensor matrix comprise one or more co-located emitters and sensors.

5. The system of claim 1, wherein the emitter matrix comprises a first set of emitters pointing in a first direction and a second set of emitters pointing in a second direction generally perpendicular to the first direction.

6. The system of claim 1, wherein the dimension of the item is determined based on counting a number of disrupted emissions of the plurality of emissions.

7. The system of claim 1, wherein the sensor matrix comprises a plurality of depth sensors, and the dimension of the item is determined based on measuring a distance between sensors of the sensor matrix and the item.

8. The system of claim 1, wherein the sensor matrix comprises an optical motion tracker and the control circuit is further configured to determine a length of the item as the item passes through the access plane of the item container.

9. The system of claim 8, wherein the control circuit is further configured to estimate a volume of the item and identify the identity of the item based at least on the volume of the item.

10. The system of claim 1, wherein the control circuit is further configured to determine whether the item is entering or exiting the item container and update the inventory information accordingly.

11. The system of claim 1, wherein the control circuit is further configured to detect a presence of a human body portion holding the item and subtract the presence the human body portion to determine the dimension of the item.

12. The system of claim 1, wherein the control circuit identifies the identity of the item based on comparing the dimension of the item with dimensions of items associated with the item container stored in the inventory database.

13. The system of claim 1, wherein when the item enters the item container, an item identifier is detected by one or more of a handheld scanner and the sensor matrix, and the control circuit is further configured to associate the dimension of the item with the item identifier in the inventory database.

14. A method for monitoring merchandise, comprising:
receiving, at a control circuit, signals from a sensor matrix configured to detect a plurality of emissions at an access plane of an item container configured to hold a plurality of items, the plurality of emissions being emitted by an emitter matrix;
measuring, with the control circuit, a dimension of an item passing through the access plane of the item container based the plurality of emissions detected by the sensor matrix;
identifying, with the control circuit, an identity of the item based at least on the dimension of the item; and
updating inventory information associated with the item container stored in an inventory database based on the identity of the item.

15. The method of claim 14, wherein the dimension of the item is determined based on counting a number of disrupted emissions of the plurality of emissions.

16. The method of claim 14, wherein the sensor matrix comprises a plurality of depth sensors, and the dimension of the item is determined based on measuring a distance between sensors of the sensor matrix and the item.

17. The method of claim 14, wherein the sensor matrix comprises an optical motion tracker and the control circuit is further configured to determine a length of item as the item passes through the access plane of the item container.

18. The method of claim 17, further comprising: estimating a volume of the item and identifying the identity of the item based on the volume of the item.

19. The method of claim 14, further comprising: determining whether the item is entering or exiting the item container and update the inventory information accordingly.

20. The method of claim 14, further comprising: detecting a presence of a human body portion holding the item and subtracting the presence the human body portion to determine the dimension of the item.

21. The method of claim 14, wherein the identity of the item is identified based on comparing the dimension of the item with dimensions of items associated with the item container stored in the inventory database.

22. The method of claim 14, further comprising:
detecting an item identifier scanned by one or more of a handheld scanner and the sensor matrix; and
associating the dimension of the item with the item identifier in the inventory database.

23. An apparatus for monitoring merchandise, comprising:
an emitter matrix configured to emit a plurality of emissions at an access plane of an item container configured to hold a plurality of items; and
a sensor matrix configured to detect the plurality of emissions to determine a dimension of an item passing through the access plane of the item container;
wherein the dimension of the item is used to identify an identity of the item and update inventory information associated with the item container stored in an inventory database.

24. A system for monitoring merchandise, comprising:
an item container configured to hold a plurality of items;
an emitter matrix positioned to generate a plurality of emissions at an access plane of the item container;
a sensor matrix positioned to detect the plurality of emissions at the access plane of the item container;
a control circuit configured to:
measure a dimension of an item passing through the access plane of the item container based the plurality of emissions detected by the sensor matrix;
receive an item identifier from scanning a machine readable optical code on the item; and
associate the dimension of the item with the item identifier in an inventory database.
